(19) United States
(12) Patent Application Publication
(10) Pub. No.: US 2024/0103481 A1
(43) Pub. Date: Mar. 28, 2024

(54) NUMERICAL CONTROLLER

(71) Applicant: FANUC CORPORATION, Minamitsuru-gun, Yamanashi (JP)

(72) Inventors: Hiroki Murakami, Minamitsuru-gun, Yamanashi (JP); Hiroyuki Kawamura, Minamitsuru-gun, Yamanashi (JP); Jirou Fujiyama, Minamitsuru-gun, Yamanashi (JP); Naoya Koide, Minamitsuru-gun, Yamanashi (JP)

(73) Assignee: Fanuc Corporation, Minamitsuru-gun, Yamanashi (JP)

(21) Appl. No.: 18/265,292

(22) PCT Filed: Dec. 23, 2021
(86) PCT No.: PCT/JP2021/047946

§ 371 Date: Jun. 5, 2023

(30) Foreign Application Priority Data
Dec. 25, 2020 (JP) 2020-216274

(51) Int. Cl. G05B 19/402

(52) U.S. Cl. CPC G05B 19/402; G05B 2219/33099; G05B 2219/35097

(57) ABSTRACT

A numerical controller includes a reading analysis unit that reads a CNC program and additional information, a path generation unit that determines a movement path of a tool, and a velocity control unit that determines a velocity for moving the tool according to the movement path of the tool, and machining errors, deterioration of a machined surface quality, or an increase in a cycle time are reduced without increasing a CNC program size and a calculation time associated with control more than necessary.

### CROSS REFERENCE TO RELATED APPLICATIONS

This is the U.S. National Phase application of PCT/JP2021/047946, filed Dec. 23, 2021, which claims priority to Japanese Patent Application No. 2020-216274, filed Dec. 25, 2020, the disclosures of each of these applications being incorporated herein by reference in their entireties for all purposes.

### FIELD OF THE INVENTION

The present invention relates to a numerical controller.

### BACKGROUND OF THE INVENTION

As illustrated in FIG. 10, a CNC (Computerized Numerical Control) program 200 generated by a CAM (Computer Aided Manufacturing) device is a list of coordinate values (coordinate values of command points 403) through which a feed axis of a machine tool needs to pass. A numerical controller reads the CNC program 200, performs path generation and velocity planning according to commanded coordinate values, moves a tool 402 by driving and controlling a driving unit of the machine tool to be controlled along an axis based on a result thereof, and machines a workpiece 401. In FIG. 10, reference numeral 404 denotes a tool path, and reference numeral 405 denotes a control point path.

A CAM device creates a tool path from an adjustable surface created on a CAD (Computer Aided Design) device and replaces the tool path with a CNC program. At this time, since the tool path is generally replaced with a set of coordinate values, information about what kind of a shape of a CAD model is, between the coordinate values is lost. For this reason, when the machine tool is controlled based on the CNC program, linear interpolation is performed between the coordinate values listed in the CNC program, or an original shape and tool path are predicted, thereby performing path generation and velocity control (For example, Patent Document 1, etc.).

### PATENT DOCUMENT

Patent Document 1: JP 2013-171376 A

### SUMMARY OF THE INVENTION

However, when the lost information is interpolated based on prediction, there is a possibility of occurrence of problems such as an error between the CAD model and a machining result (degraded machining accuracy), deterioration of a machined surface quality due to fluctuation in a machining velocity, and an increase in a cycle time due to occurrence of unnecessary deceleration (occurring as a result of overestimating acceleration). A method of reducing an allowable error to less than 1 μm when the CNC program is generated using the CAM device may be adopted to reduce the error between the CAD model and the machining result. However, when such a method is adopted, other problems arise, such as an increase in a size of the CNC program and an increase in calculation time.

Technology is desired to reduce machining errors, deterioration of machined surface quality, or an increase in a cycle time without significantly increasing a CNC program size and a calculation time associated with control.

A numerical controller according to the present invention adds additional information related to a shape, which is lost when a CAM device generates a CNC program, to the CNC program. The added additional information may include curvature, a radius of curvature, a curve function, etc. In addition, the numerical controller according to the present invention uses the additional information when executing the CNC program to perform a correction process of command coordinates, an interpolation process between command coordinates, or a velocity control process. In these processes, the additional information is directly used without changing a numerical control parameter. Note that the additional information may be transferred to the numerical controller together with the CNC program (commanded coordinate values), or may be transferred to the numerical controller by means separate from the CNC program (commanded coordinate values).

Further, an aspect of the present invention is a numerical controller for controlling a machine including a tool based on a CNC program including a plurality of command points for commanding movement of the tool, the numerical controller including a reading analysis unit configured to read the CNC program and additional information of the CNC program, a path generation unit configured to determine a movement path of the tool, and a velocity control unit configured to determine a velocity for moving the tool according to the movement path of the tool. The additional information is used to generate a path between command points including command points by the path generation unit. Further, the additional information includes at least one of required surface roughness of a workpiece, dimensions of a drawing, a workpiece shape represented by a formula, torsion of a tool path, a tool path represented by a formula, a change amount of a tool vector, jerk of a tool tip point, torsion of a cutting point path, a cutting point path represented by a formula, jerk of a cutting point path, a preset accuracy level, curvature of a workpiece, curvature of a tool path, curvature of a cutting point path, acceleration of a tool tip point, acceleration of a cutting point path, and required accuracy of a workpiece.

One aspect of the present invention can improve machining accuracy without increasing a size of a program (the number of commanded coordinate points) and a calculation time.

### BRIEF DESCRIPTION OF DRAWINGS

FIG. 1 is a schematic hardware configuration diagram of a controller according to a first embodiment;

FIG. 2 is a schematic block diagram illustrating functions of the controller according to the first embodiment;

FIG. 3 is a diagram illustrating an example in which additional information is given by a radius of curvature;

FIG. 4 is a diagram illustrating an example in which additional information is given by a formula;

FIG. 5 is a diagram illustrating an example of a command point row to which a command point needs to be added;

FIG. 6 is a diagram illustrating an example of a command point row to which a command point is added;

FIG. 7 is a diagram illustrating an example of a command point to be deleted;

FIG. 8 is a diagram illustrating an example of a command point, a position of which is to be corrected;

FIG. 9 is a diagram illustrating an example of smoothing processing; and

FIG. 10 is a diagram illustrating an example of a CNC program and a machining path according to conventional technology.

### DETAILED DESCRIPTION OF EMBODIMENTS OF THE INVENTION

Hereinafter, embodiments of the present invention will be described with reference to the drawings.

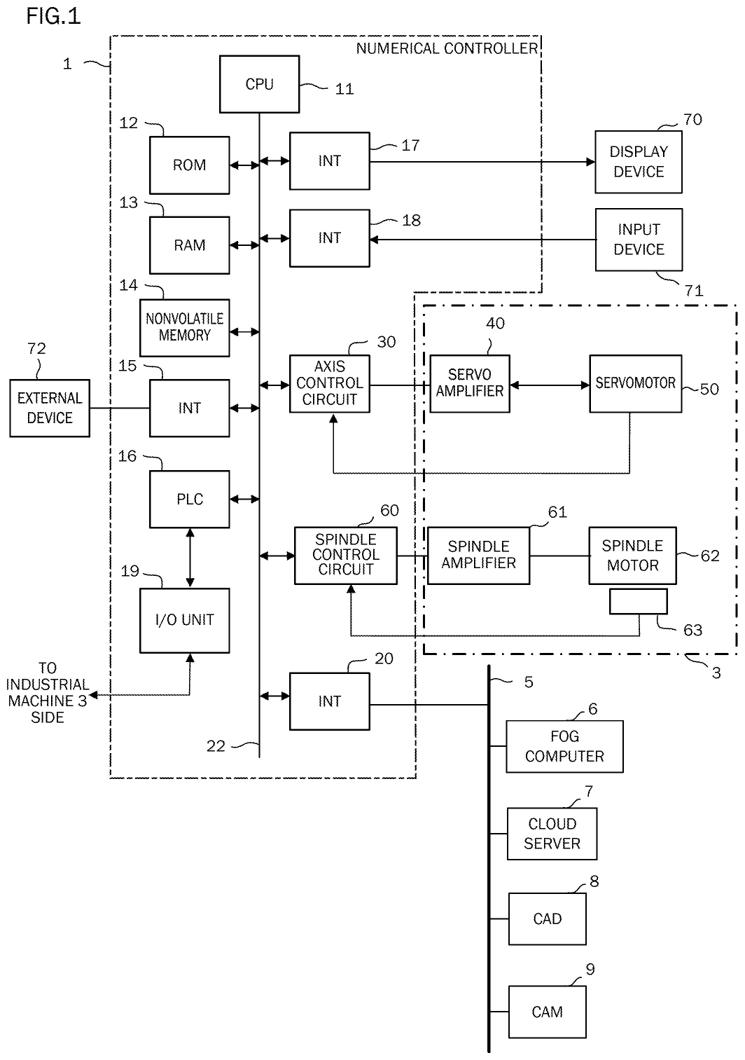

FIG. 1 is a schematic hardware configuration diagram illustrating main parts of a numerical controller according to a first embodiment of the present invention. The numerical controller 1 has a function of controlling an industrial machine 3 such as a machine tool or a 5-axis machine based on a CNC program.

A CPU 11 included in the numerical controller 1 according to the present embodiment is a processor that controls the numerical controller 1 as a whole. The CPU 11 reads a system program stored in a ROM 12 via a bus 22 and controls the entire numerical controller 1 according to the system program. A RAM 13 temporarily stores temporary calculation data or display data, various data input from the outside, etc.

For example, a nonvolatile memory 14 includes a memory backed up by a battery (not illustrated), an SSD (Solid State Drive), etc., and retains a storage state even when power of the numerical controller 1 is turned off. The nonvolatile memory 14 stores a control program and data read from an external device 72 via an interface 15, a control program and data input from an input device 71 via an interface 18, and a control program and data acquired from another device such as a fog computer 6 or a cloud server 7 via a network 5, etc. For example, the data stored in the nonvolatile memory 14 may include data related to a position, velocity, acceleration, and load of each motor included in the industrial machine 3, each of other physical quantities detected by sensors (not illustrated) attached to the industrial machine 3, etc. The control program and data stored in the nonvolatile memory 14 may be loaded in the RAM 13 during execution/use. In addition, various system programs such as a known analysis program are written to the ROM 12 in advance.

The interface 15 is an interface for connecting the CPU 11 of the numerical controller 1 and the external device 72 such as an external storage medium to each other. From the external device 72 side, for example, a control program used to control the industrial machine 3, setting data, etc. are read. In addition, a control program, setting data, etc. edited in the numerical controller 1 may be stored in the external storage medium such as a CF card or a USB memory (not illustrated) via the external device 72. A PLC (Programmable Logic Controller) 16 executes a ladder program to output a signal to the industrial machine 3 and peripheral devices of the industrial machine 3 (for example, a tool changer, an actuator such as a robot, and a sensor such as a temperature sensor or a humidity sensor attached to the industrial machine 3) via an I/O unit 19, thereby performing a control operation. In addition, the PLC 16 receives signals of various switches on an operation panel disposed on a main body of the industrial machine 3 or the peripheral devices, performs necessary signal processing, and then transfers the signals to the CPU 11.

An interface 20 is an interface for connecting the CPU 11 of the numerical controller 1 and the wired or wireless network 5. For example, the network 5 may perform communication using techniques such as serial communication such as RS-485, Ethernet (registered trademark) communication, optical communication, wireless LAN, Wi-Fi (registered trademark), and Bluetooth (registered trademark). Other devices such as a CAD device 8 and a CAM device 9, and host management devices such as a fog computer 6 and a cloud server 7 are connected to the network 5 to mutually exchange data with the numerical controller 1.

Each piece of data read into a memory, and data, etc. obtained as a result of executing a program, etc. are output to and displayed on a display device 70 via an interface 17. In addition, the input device 71 including a keyboard, a pointing device, etc., transfers a command, data, etc. based on an operation by an operator to the CPU 11 via the interface 18.

An axis control circuit 30 for driving a driving unit included in the industrial machine 3 along an axis receives a movement command amount related to the axis from the CPU 11 and outputs each command related to the axis to a servo amplifier 40. The servo amplifier 40 receives this command and drives each servomotor 50 for moving the driving unit included in the industrial machine 3 along the axis. The servomotor 50 of the axis incorporates a position/velocity detector, feeds back each position/velocity feedback signal from the position/velocity detector to the axis control circuit 30, and performs position/velocity feedback control. Note that, even though only one axis control circuit 30, one servo amplifier 40, and one servomotor 50 are illustrated in the hardware configuration diagram of FIG. 1, in practice, each of the numbers of prepared axis control circuits 30, servo amplifiers 40, and servomotors 50 equals the number of axes included in the industrial machine 3 to be controlled.

A spindle control circuit 60 receives a main shaft rotation command and outputs a spindle velocity signal to a spindle amplifier 61. The spindle amplifier 61 receives this spindle velocity signal and rotates a spindle motor 62 of the industrial machine 3 at a commanded rotation velocity. A position coder 63 is coupled to the spindle motor 62, the position coder 63 outputs a feedback pulse in synchronization with rotation of a main shaft, and the feedback pulse is read by the CPU 11.

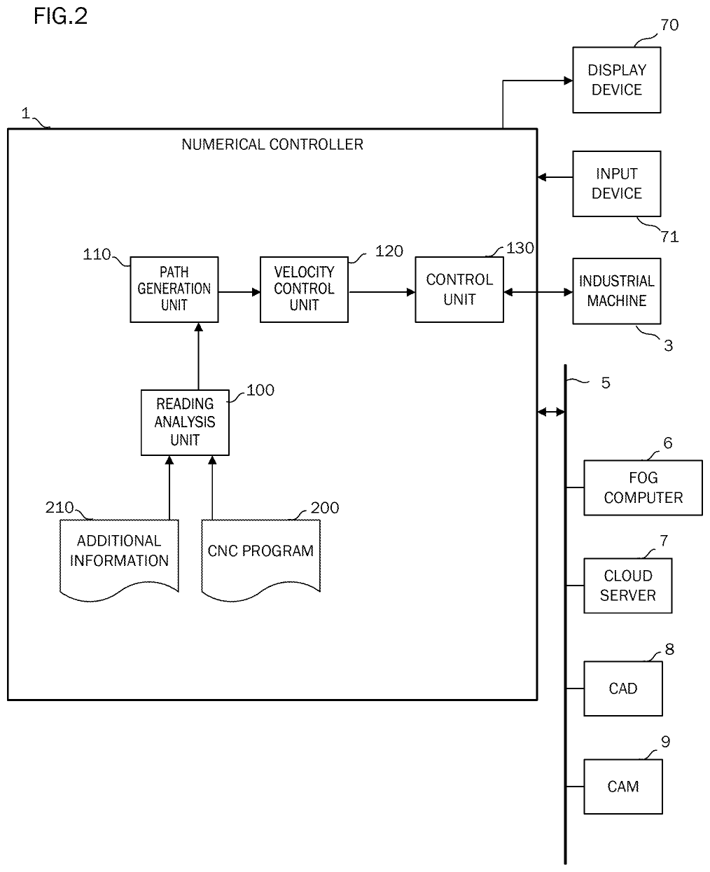

FIG. 2 illustrates, as a schematic block diagram, functions of the numerical controller 1 according to the first embodiment of the present invention. Each function provided in the numerical controller 1 according to the present embodiment is realized by the CPU 11 provided in the numerical controller 1 illustrated in FIG. 1 executing a system program and controlling an operation of each unit of the numerical controller 1.

The numerical controller 1 of the present embodiment includes a reading analysis unit 100, a path generation unit 110, a velocity control unit 120, and a control unit 130. In addition, a CNC program 200 used to control the industrial machine 3 and additional information 210 related to the CNC program 200 are stored in the RAM 13 or the nonvolatile memory 14 of the numerical controller 1.

The reading analysis unit 100 is realized by the CPU 11 included in the numerical controller 1 illustrated in FIG. 1 executing a system program read from the ROM 12 and performing arithmetic processing using the RAM 13 and the nonvolatile memory 14 mainly by the CPU 11. The reading analysis unit 100 reads and analyzes the CNC program 200 and additional information related to the CNC program, and associates and outputs each command and the additional information included in the CNC program 200. The additional information 210 associated with each command may include a shape, required quality, and required accuracy of a workpiece in a range of machining by each command, acceleration and jerk of a tool, etc. More specifically, the additional information 210 may include curvature of a workpiece in the range of machining by each command, dimensions of a drawing, a workpiece shape represented by a formula, curvature of a tool path, torsion of a tool path, a tool path represented by a formula, the change amount of a tool vector, curvature of a cutting point path, a cutting point path represented by a formula, torsion of a cutting point path, required surface roughness of a workpiece, a preset accuracy level, required accuracy of a workpiece, acceleration of a tool tip point, acceleration of a cutting point path, jerk of a tool tip point, jerk of a cutting point path, etc.

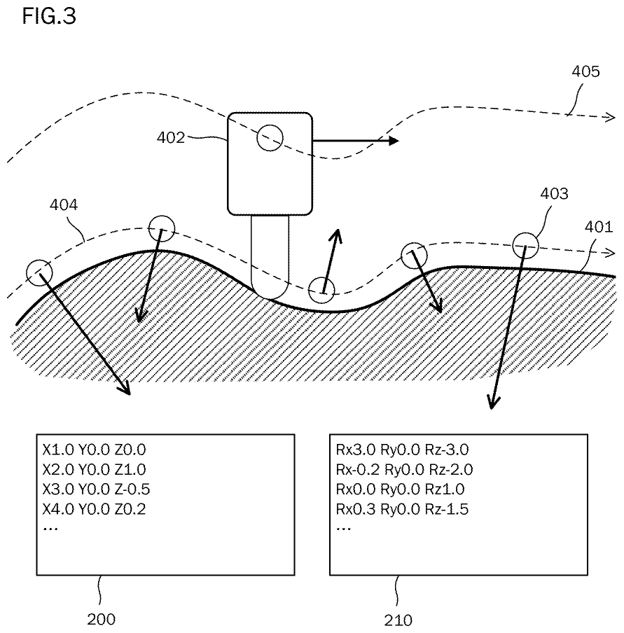

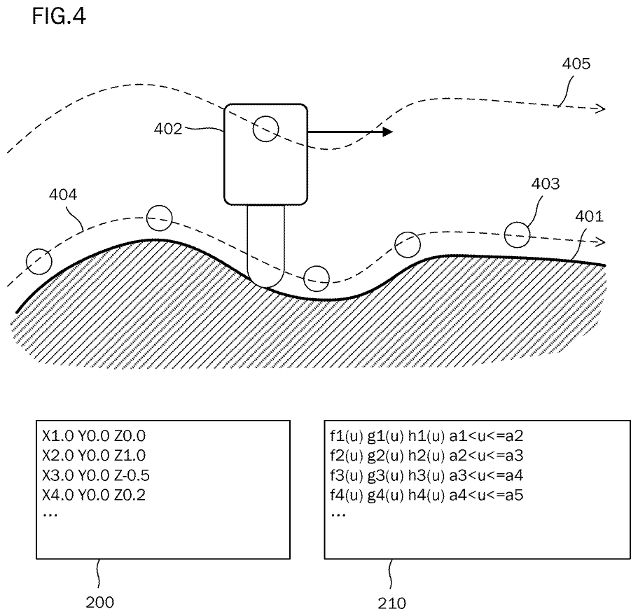

The additional information 210 may be created in any format as long as the additional information 210 can be associated with each command of the CNC program 200. For example, as illustrated in FIG. 3, the additional information 210 may be created so that each position (number of lines, etc.) of the additional information 210 corresponds to a position (number of lines, etc.) of each command in the CNC program 200, or correspondence may be identifiable by a block number, etc. In addition, separate code, etc. may be assigned so that a corresponding relationship is identifiable. Furthermore, the additional information 210 may be added within the CNC program 200 near a corresponding command (for example, after the command). In the example of FIG. 3, respective axial direction components of X, Y, and Z of a radius of curvature are indicated by Rx, Ry, and Rz as the additional information. The additional information may indicate information at a command point position. For example, curvature, etc. may indicate curvature at a current command point. Meanwhile, the additional information may indicate information related to processing of a curve from a previous command point to a current command point. For example, when a tool path represented by a formula is used as additional information, as illustrated in FIG. 4, a path indicating a curve from a previous command point to a current command point may be represented by a formula having a predetermined intervening variable as a parameter, or may be represented by a general polynomial expressed by x, y, and z (including a linear expression), a NURBS curve, a circular arc function, etc. and a range thereof. The formula, torsion, jerk, etc. are suitable for indicating information related to processing of a curve from a previous command point to a current command point.

The path generation unit 110 is realized by the CPU 11 included in the numerical controller 1 illustrated in FIG. 1 executing a system program read from the ROM 12 and performing arithmetic processing using the RAM 13 and the nonvolatile memory 14 mainly by the CPU 11. The path generation unit 110 generates a tool path between command points based on each command included in the CNC program 200 input from the reading analysis unit 100 and the additional information 210 associated with the command.

For example, when radii of curvature Rₓᵢ, R_{yi}, and R_{zi} at a command point Pᵢ are given to a cutting command reaching the command point Pᵢ by the additional information 210, and radii of curvature Rₓᵢ₊₁, R_{yi+1}, and R_{zi+1} are given to a cutting command reaching a command point Pᵢ₊₁, the path generation unit 110 sets the command point Pᵢ and the command point Pᵢ₊₁ to a start point and an end point, respectively, and calculates, as a tool path, a curve in which the radii of curvature are Rₓᵢ, R_{yi}, and R_{zi} near the command point Pᵢ and the radii of curvature are Rₓᵢ₊₁, R_{yi+1}, and R_{zi+1} near the command point Pᵢ₊₁. In addition, when torsion τ(s) is given together with curvature, it is possible to calculate, as a tool path, a curve of the torsion τ(s) with a plane including an axial direction vector of the tool and a movement direction vector of the tool as a reference plane. When a tool path represented by a formula is given, it may calculate a curve in which command points Pᵢ and Pᵢ₊₁ calculated by the formula are set as a start point and an end point, respectively, as the tool path. When the additional information 210 related to the workpiece and the additional information 210 related to the cutting point path are given, it may calculate a tool path on which a workpiece shape and a cutting point path designated in consideration of a tool length, a tool width, etc. are obtained.

Further, the path generation unit 110 may add or delete a command point or correct a position of a command point when there is a disorder in an array of a command point row including a plurality of command points commanded by the CNC program 200 as necessary, so that a smoother machined surface can be obtained.

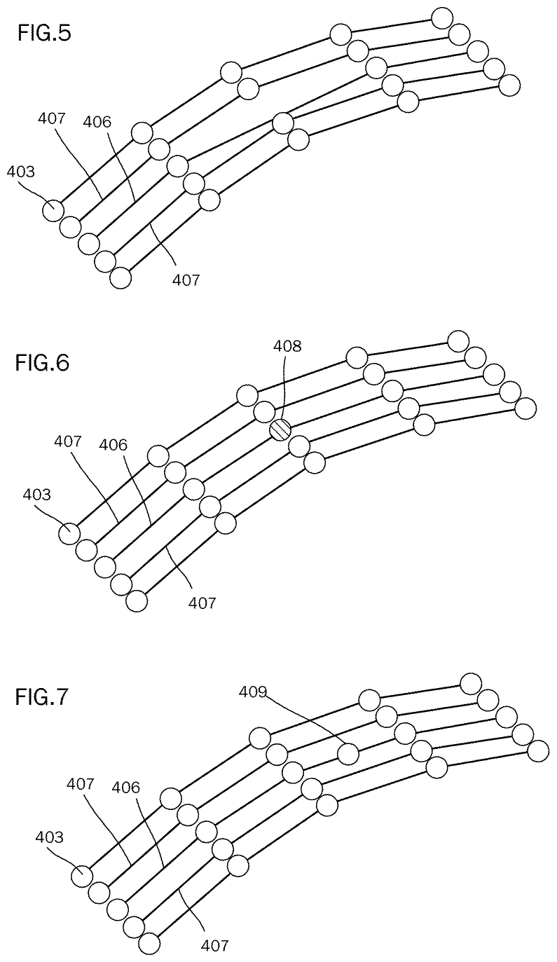

For example, as illustrated in FIG. 5, it is presumed that there is a command path 406 in which a command point 403 is lost when compared to an adjacent command path 407. In such a case, as illustrated in FIG. 6, a command point 408 is added so that a step between the command path 406 and the adjacent command path 407 becomes smaller. When performing such processing, it is possible to accurately determine a position of the additional command point 408 by referring to curvature, a path formula, etc. given as additional information associated with a command.

In addition, as illustrated in FIG. 7, it is presumed that an unnecessary command point 409 (a point which is redundant even though the point is within a tolerance when compared to a command path without the command point or an adjacent command path) is included when compared to the adjacent command path 407. In such a case, it is possible to determine whether or not the point needs to be deleted by referring to curvature, a path formula, etc. given as additional information associated with a command. For example, by deleting the command point 409 when the amount of deviation from the path formula is large only at the command point 409, or when only the vicinity of the command point 409 of the command path protrudes and has small or large curvature even though there is no significant change in curvature of the additional information 210, a step with respect to the adjacent command point is eliminated, and a clean machined surface is obtained.

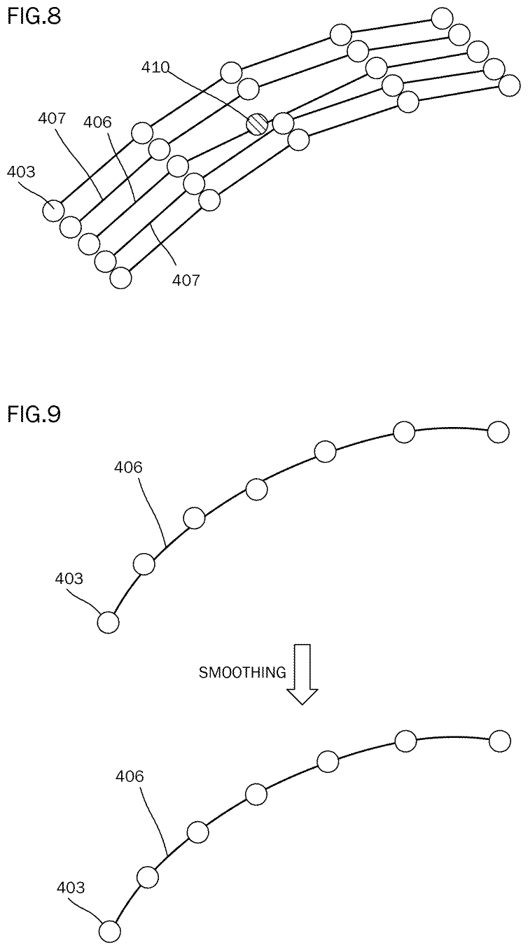

Similarly, as illustrated in FIG. 8, by correcting a position of the command point 410 while referring to the additional information when the amount of deviation from the path formula included in the additional information is large at a command point 410 when compared to the adjacent command path 407, or when only the vicinity of the command point 410 protrudes and has small or large curvature even though there is no significant change in curvature of the additional information, a step with respect to the adjacent command point is eliminated, and a clean machined surface is obtained.

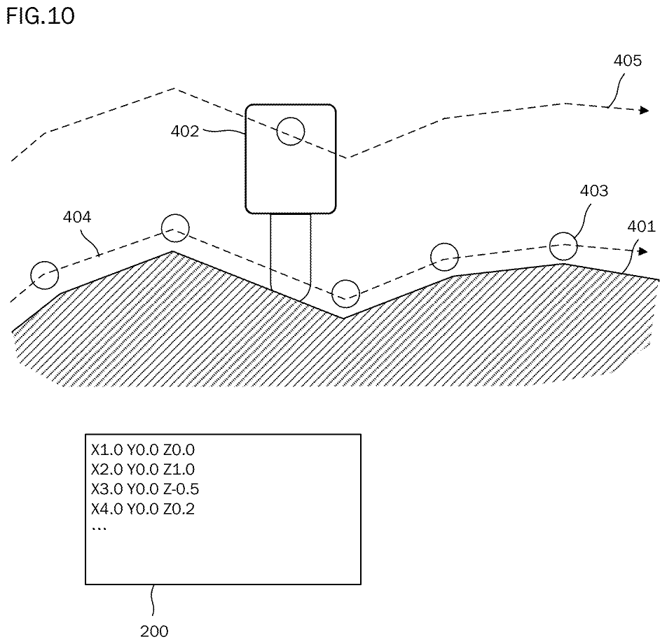

Furthermore, the path generation unit 110 may perform smoothing processing on the command point row including the plurality of command points. For example, as illustrated in FIG. 9, when an approximation curve is created from the command point row using the method of least squares, etc., a shift may be generated between the command points and the approximation curve. When variation in curvature in a certain section is small, or when curvature gently changes, it is possible to determine that the path can be approximated by a low-order polynomial such as a second-order or third-order polynomial in this section. Thus, it is considered that the shift between the command points and the approximation curve is caused by some calculation errors. Therefore, it is possible to determine that tool movement does not need to follow this shift. When such determination is performed, it is possible to accurately determine whether or not tool movement needs to follow the shift by referring to curvature, a path formula, etc. given as additional information associated with the command. When it is determined that there is no need for following, the path generation unit 110 may smooth each command point and perform smoothing processing for correcting the command path to a smooth one.

This smoothing may be carried out on an approximation curve, or smoothing may be performed by applying some type of filter such as a movement average filter.

The velocity control unit 120 is realized by the CPU 11 included in the numerical controller 1 illustrated in FIG. 1 executing a system program read from the ROM 12 and performing arithmetic processing using the RAM 13 and the nonvolatile memory 14 mainly by the CPU 11. The velocity control unit 120 calculates a movement velocity of the tool according to a path.

For example, when additional information related to machining quality of the workpiece (required surface roughness of the workpiece, required accuracy of the workpiece, etc.) is given to a cutting command for moving the tool from the command point Pᵢ to the command point Pᵢ₊₁ by additional information, the velocity control unit 120 calculates a movement velocity of the tool so that acceleration and jerk become upper limit acceleration and jerk within a range in which the quality can be satisfied when moving on the tool path for machining. Ranges of curvature, etc., acceleration, and jerk of the tool path satisfying a predetermined quality may be obtained in advance by an experiment, etc. and stored in the nonvolatile memory 14. For example, in a simplest model of surface roughness, a relationship between surface roughness R and a velocity V can be expressed by Equation (1) below. Note that Const is a predetermined constant. Therefore, the velocity V obtained as a result of solving Equation 1 may be set as a velocity limit, and the velocity may be controlled by controlling acceleration and jerk within a range in which the velocity is not exceeded on a curve, etc.

R=Const×V² [Equation 1]

In addition, when additional information related to acceleration and jerk of the tool is given, the movement velocity of the tool is calculated so that the tool moves at acceleration, maximum acceleration, and jerk given when moving on the tool path for machining. In addition, when a formula f(s) and torsion τ(s) indicating curvature and the tool path are given as additional information, acceleration A and jerk J may be obtained using Equation 3 and Equation 4 based on Equation 2 indicated below (Frenet-Serret formulas). Note that, in Equations 2, 3, and 4, s (>0) denotes a path length parameter, κ denotes curvature, τ denotes torsion, T denotes a tangent vector, n denotes a normal vector, b denotes a normal vector, and V denotes the absolute value of a velocity.

$$\frac{d}{ds} ( \begin{matrix}T \\ n \\ b\end{matrix} ) = ( \begin{matrix}0 & κ & 0 \\ - κ & 0 & τ \\ 0 & - τ & 0\end{matrix} ) ( \begin{matrix}T \\ n \\ n\end{matrix} ) \qquad [ Equation 2 ]$$

$$A = \vert \frac{{d}^{2} f ( s )}{d {t}^{2}} \vert = {V}^{2} κ \qquad [ Equation 3 ]$$

$$where$$

$$V = \vert \frac{d f ( s )}{d t} \vert = \vert \frac{df ( s )}{ds} \frac{ds}{dt} \vert = \frac{ds}{dt}$$

$$J = \vert \frac{{d}^{3} f ( s )}{d {t}^{3}} \vert = {V}^{3} κ \sqrt{{κ}^{2} + {τ}^{2}} \qquad [ Equation 4 ]$$

Note that generation of the tool path by the path generation unit 110 based on the additional information 210 and control of the movement velocity of the tool by the velocity control unit 120 based on the additional information 210 do not necessarily need to be performed at the same time. For example, only generation of the tool path by the path generation unit 110 based on the additional information 210 may be performed, or only control of the movement velocity of the tool by the velocity control unit 120 based on the additional information 210 may be performed. These path generation and velocity control may be appropriately and selectively performed according to the purpose of machining.

The control unit 130 is realized by the CPU 11 included in the numerical controller 1 illustrated in FIG. 1 executing a system program read from the ROM 12 and performing arithmetic processing using the RAM 13 and the nonvolatile memory 14 mainly by the CPU 11 and control processing of the industrial machine 3 using the axis control circuit 30. The control unit 130 controls movement of the driving unit of the industrial machine 3 based on the tool path generated by the path generation unit 110 and the movement velocity determined by the velocity control unit 120. The control unit 130 controls the tool path and the movement velocity of the tool by distributing the movement amount to each axis control circuit 30 so that the movement path of the tool becomes the tool path generated by the path generation unit 110 and the movement velocity of the tool becomes the movement velocity determined by the velocity control unit 120.

The numerical controller 1 having the above configuration can generate the tool path based on the additional information 210 and improve machining accuracy between the command points by giving the additional information 210 related to a shape of the workpiece created by a CAD to each command point. This processing does not particularly need to increase command points in CAM, and thus can be implemented without increasing the size (the number of commanded coordinate points) of the CNC program 200 and the calculation time more than necessary. In addition, by giving additional information related to a velocity for each command point, more appropriate acceleration/deceleration control becomes possible, improvement in the cycle time and improvement in machining accuracy can be expected, and further obtaining a smoother machined surface is expected. Referring to such an effect, rather than giving additional information only by curvature and a radius of curvature, when additional information is given particularly in other forms, the tool path between the command points can be approximated to the shape of the workpiece created by the CAD, and a significant effect can be expected. In addition, the velocity can be controlled according to an appropriately expressed tool path, and thus it is also possible to expect maintaining a finely designated quality.

Even though one embodiment of the present invention has been described above, the present invention is not limited only to the above-described examples of the embodiment, and can be implemented in various modes by adding appropriate modifications.

For example, in the above described embodiment, a mode in which the additional information 210 is stored in the RAM 13 or the nonvolatile memory 14 of the numerical controller 1 is illustrated. However, for example, the CNC program 200 and the additional information 210 may perform machining while being read directly from the CAD device 8 or the CAM device 9 via the network 5, or may similarly perform machining while being read from the fog computer 6 or the cloud server 7 via the network 5.

### EXPLANATIONS OF LETTERS OR NUMERALS

1 NUMERICAL CONTROLLER
3 INDUSTRIAL MACHINE
5 NETWORK
6 FOG COMPUTER
7 CLOUD SERVER
8 CAD DEVICE
9 CAM DEVICE
11 CPU
12 ROM
13 RAM
14 NONVOLATILE MEMORY
15, 17, 18, 20 INTERFACE
16 PLC
19 I/O UNIT
22 BUS
30 AXIS CONTROL CIRCUIT
40 SERVO AMPLIFIER
50 SERVOMOTOR
70 DISPLAY DEVICE
71 INPUT DEVICE
72 EXTERNAL DEVICE
100 READING ANALYSIS UNIT
110 PATH GENERATION UNIT
120 VELOCITY CONTROL UNIT
130 CONTROL UNIT
200 CNC PROGRAM
210 ADDITIONAL INFORMATION

1. A numerical controller for controlling a machine including a tool based on a CNC program including a plurality of command points for commanding movement of the tool, the numerical controller comprising:
a reading analysis unit configured to read the CNC program and additional information of the CNC program;
a path generation unit configured to determine a movement path of the tool; and
a velocity control unit configured to determine a velocity for moving the tool according to the movement path of the tool, wherein:
the additional information is used to generate a path between command points including command points by the path generation unit; and
the additional information includes at least one of required surface roughness of a workpiece, dimensions of a drawing, a workpiece shape represented by a formula, torsion of a tool path, a tool path represented by a formula, a change amount of a tool vector, jerk of a tool tip point, torsion of a cutting point path, a cutting point path represented by a formula, jerk of a cutting point path, a preset accuracy level, curvature of a workpiece, curvature of a tool path, curvature of a cutting point path, acceleration of a tool tip point, acceleration of a cutting point path, and required accuracy of a workpiece.

2. A numerical controller for controlling a machine including a tool based on a CNC program including a plurality of command points for commanding movement of the tool, the numerical controller comprising:
a reading analysis unit configured to read the CNC program and additional information of the CNC program;
a path generation unit configured to determine a movement path of the tool; and
a velocity control unit configured to determine a velocity for moving the tool according to the movement path of the tool, wherein:
the additional information is used to determine the velocity for the moving by the velocity control unit; and
the additional information includes at least one of required surface roughness of a workpiece, dimensions of a drawing, a workpiece shape represented by a formula, torsion of a tool path, a tool path represented by a formula, a change amount of a tool vector, jerk of a tool tip point, torsion of a cutting point path, a cutting point path represented by a formula, a change amount of a tool vector, jerk of a cutting point path, and a preset accuracy level.

3. The numerical controller according to claim 1, wherein the velocity control unit uses information about the movement path of the tool determined by the path generation unit based on the additional information.

4. The numerical controller according to claim 2, wherein the velocity control unit further uses at least one of curvature of a workpiece, curvature of a tool path, curvature of a cutting point path, acceleration of a tool tip point, acceleration of a cutting point path, and required accuracy of a workpiece as additional information.

5. The numerical controller according to claim 1, wherein the additional information is added in the CNC program.

6. The numerical controller according to claim 1, wherein the additional information is described separately from the CNC program.

7. The numerical controller according to claim 1, wherein the path generation unit uses curvature of a tool path and required accuracy of a workpiece as the additional information.

8. The numerical controller according to claim 1, wherein the path generation unit adds or deletes a command point commanded by the CNC program.

9. The numerical controller according to claim 1, wherein the path generation unit determines a movement path of the tool by smoothing a command point row including a plurality of command points commanded by the CNC program.

10. The numerical controller according to claim 2, wherein the velocity control unit uses information about the movement path of the tool determined by the path generation unit based on the additional information.

11. The numerical controller according to claim 2, wherein the additional information is added in the CNC program.

12. The numerical controller according to claim 2, wherein the additional information is described separately from the CNC program.
